(19) United States
(12) Patent Application Publication
(10) Pub. No.: US 2010/0278718 A1
(43) Pub. Date: Nov. 4, 2010

(54) Method for making monodisperse silver and silver compound nanocrystals

(75) Inventors: Ya-Dong Li, Beijing (CN); Ding-Sheng Wang, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: Tsinghua University, Beijing City (CN); HON HAI Precision Industry CO., LTD., Tu-Cheng City (TW)

(21) Appl. No.: 12/002,139

(22) Filed: Dec. 14, 2007

(30) Foreign Application Priority Data
Mar. 30, 2007 (CN) 200710073766.2

(51) Int. Cl. C01B 19/04; C01B 17/20; B22F 9/18

(52) U.S. Cl. 423/509; 423/565; 75/371; 75/364; 977/773; 977/896

(57) ABSTRACT

A method for making monodisperse silver nanocrystals includes the following step: (1) mixing a silver nitrate with octadecyl amine as a solvent, and achieving a mixture; (2) agitating and reacting the mixture at a reaction temperature for a reaction period; (3) cooling the mixture to a cooling temperature, and achieving a deposit; and (4) washing the deposit with an organic solvent, drying the deposit at a drying temperature, and achieving monodisperse silver nanocrystals. After step (2), the method can further include a step of mixing a sulfur or selenium into the reactant to achieve monodisperse silver sulfide or silver selenide nanocrystals.

### RELATED APPLICATIONS

This application is related to commonly-assigned, co-pending application: U.S. patent application Ser. No. ______, entitled “METHOD FOR MAKING MESOPOROUS MATERIAL”, filed ______ (Atty. Docket No. US13845) and U.S. patent application Ser. No. ______, entitled “METHOD FOR MAKING COLLOIDAL NANOCRYSTALS”, filed ______ (Atty. Docket No. US13847). The disclosure of the above-identified application is incorporated herein by reference.

### BACKGROUND

1. Field of the Invention

The present invention relates to a method for making monodisperse nanocrystals and, particularly, to a method for making monodisperse silver and silver compound nanocrystals.

2. Discussion of Related Art

Nanocrystals are defined as nanometer sized, single crystalline fragments of the corresponding bulk crystals. The term “nanometer-sized” is typically used to refer to particles with an approximate size range between about 1 nanometer (nm) to about 1000 nm in diameter. More typically, “nanometer-sized” refers to an approximate size range between about 1 nm-100 nm in diameter. Metal and metal compound nanocrystals play important roles in many different branches of science and technology, for use in catalyzer materials, lithium cells, and electronic and optical devices.

Synthesis of high quality monodisperse silver and silver compound nanocrystals has a critical role in the chemical field. Conventional methods include metal organic salt reduction, hydro-thermal, and sol-gel methods. However, the metal organic salt reduction method requires the use of metal precursors, which are extremely toxic, expensive, and unstable at room temperature, the hydro-thermal method is restricted by product and/or apparatus, and the sol-gel method is not good at controlling the size and the size distribution of nanocrystals.

Therefore, there is an ongoing demand for a simple, timesaving, low toxic, easy to mass produce method for making monodisperse silver and silver compound nanocrystals with good size control, narrow size distribution, and good crystallinity.

### SUMMARY OF THE INVENTION

A method for making monodisperse silver nanocrystals comprising: (1) mixing a silver nitrate with octadecyl amine as a solvent, and achieving a mixture; (2) agitating and reacting the mixture at a reaction temperature for a reaction period; (3) cooling the mixture to a cooling temperature, and achieving a deposit; and (4) washing the deposit with an organic solvent, drying the deposit at a drying temperature, and achieving monodisperse silver nanocrystals.

A method for making monodisperse silver sulfide comprising: (1) mixing a silver nitrate with octadecyl amine as a solvent, and achieving a mixture; (2) agitating and reacting the mixture at a reaction temperature for a first reaction period; (3) mixing a sulfur or selenium solid into the reactant and reacting for a second reaction period, a mole ratio of silver nitrate to sulfur with 2:1; (4) cooling to a cooling temperature, and achieving a deposit; and (5) washing the deposit with an organic solvent, drying the deposit at a drying temperature, and achieving monodisperse silver sulfide or silver selenide nanocrystals.

Compared with the conventional method, with the inorganic metal salt and octadecyl amine as the raw material, the present methods for making monodisperse silver and silver compound nanocrystal are economical, timesaving and low toxic, and thus are suitable for industrial mass production. The monodisperse silver and silver compound nanocrystals made by the present method have good size control, narrow size distribution and good crystallinity, and therefore have significant advantages for applications in catalysis, ceramics, energy storage, magnetic data storage, sensors, ferrofluids, etc.

### BRIEF DESCRIPTION OF THE DRAWINGS

Many aspects of the present method can be better understood with reference to the following drawings. The components in the drawings are not necessarily to scale, the emphasis instead being placed upon clearly illustrating the principles of the present method.

FIG. 1 is a transmission electron microscope (TEM) image of monodisperse silver nanocrystals according to a first embodiment.

FIG. 2 is a TEM image of monodisperse silver sulfide nanocrystals according to a second embodiment.

FIG. 3 is a TEM image of monodisperse silver selenide nanocrystals according to a third embodiment.

FIG. 4 is a X-ray diffraction (XRD) image of monodisperse silver, silver sulfide, silver selenide nanocrystals according to above embodiments.

The exemplifications set out herein illustrate at least one preferred embodiment of the present method, in one form, and such exemplifications are not to be construed as limiting the scope of the invention in any manner.

### DETAILED DESCRIPTION OF PREFERRED EMBODIMENTS

Reference will now be made, in detail, to the drawings to describe embodiments of the present method.

One method for making monodisperse silver nanocrystals includes the following steps: mixing 0.1-1 gram (g) of a silver nitrate (AgNO3) with about 10 milliliters (ml) of octadecyl amine, and forming a mixture; agitating and reacting the mixture at a temperature of 160-300° C. for a period of 1-10 minutes (m); cooling the mixture to a temperature of 70-90° C., and achieving a deposit; washing the deposit with an organic solvent such as ethanol, drying the deposit at a temperature of 40-80° C., and finally achieving monodisperse silver nanocrystals with a diameter of 6-12 nanometers (nm). The chemical equation is as follows:

2AgNO₃→2Ag+2NO₂+O₂

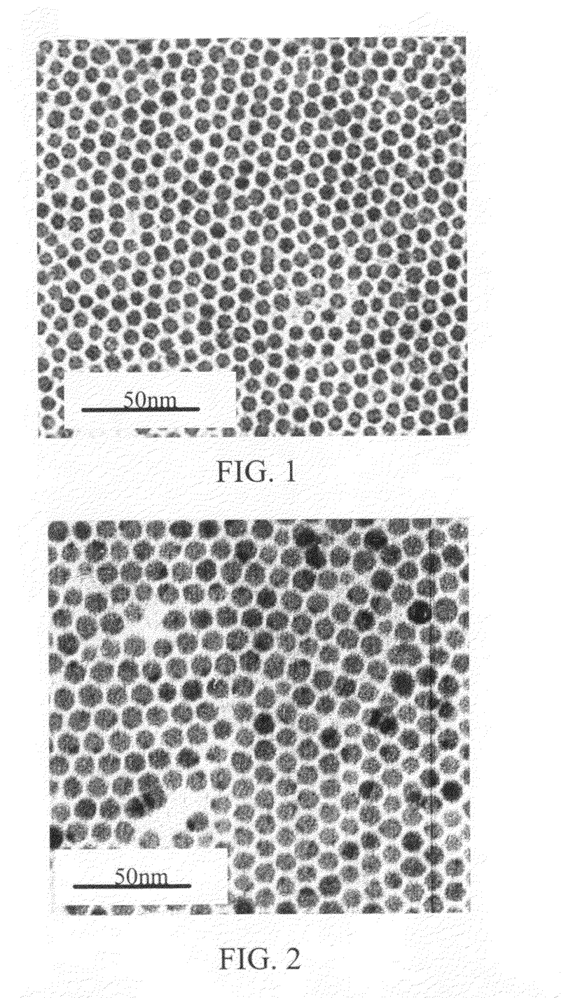

In a first embodiment, 1 g of AgNO3 solid is dissolved in 10 ml octadecyl amine, and a mixture is achieved. The mixture is agitated and reacted at a temperature of 200° C. for 10 minutes and then cooled to 80° C., and a deposit is achieved. The deposit is washed with ethanol and dried at a temperature of 40-80° C. Referring to FIG. 1, monodisperse silver nanocrystals with a diameter of about 4.7 nm are achieved.

One method for making monodisperse silver sulfide nanocrystals includes the following steps: mixing 0.1-1 g of a AgNO3 with about 10 ml of octadecyl amine , and forming a mixture; agitating and reacting the mixture at a temperature of 160-300° C. for a period of 1-10 minutes; mixing a sulfur (S) solid into the reactant and reacting for a period of 8-12 minutes, achieving a mole ratio of AgNO3 to S of 2:1; cooling the mixture to a temperature of 70-90° C., and achieving a deposit; washing the deposit with an organic solvent such as ethanol, drying the deposit at a temperature of 40-80° C., and achieving monodisperse silver sulfide nanocrystals with a diameter of 6-12 nanometers (nm). The chemical equation is as follows:

2AgNO₃→2Ag+2NO₂+O₂

2Ag+S→Ag₂S

In a second embodiment, 0.85 g of AgNO3 solid are dissolved in 10 ml octadecyl amine, and a mixture is achieved. The mixture is agitated and reacted at a temperature of 200° C. for 10 minutes. 0.08 g of S is mixed into the reactant, and the mixture is reacted for a period 10 minutes. The reactant is cooled to 80° C., and a deposit is achieved. The deposit is washed with ethanol and dried at a temperature of 40-80° C. Referring to FIG. 2, monodisperse silver sulfide nanocrystals with a diameter of about 7.3 nm are achieved.

One method for making monodisperse silver selenide nanocrystals includes the following steps: mixing 0.1-1 g of AgNO3 with about 10 ml of octadecyl amine, and forming a mixture; agitating and reacting the mixture at a temperature of 160-300° C. for a period of 1-10 minutes; mixing a selenium (Se) solid into the reactant and reacting for a period of 8-12 minutes, achieving a mole ratio of AgNO3 to Se of 2:1; cooling the mixture to a temperature of 70-90° C., and achieving a deposit; washing the deposit with an organic solvent such as ethanol, drying the deposit at a temperature of 40-80° C., and achieving monodisperse silver selenide nanocrystals with a diameter of 6-12 nm. The chemical equation is as follows:

2AgNO₃→2Ag+2NO₂+O₂

2Ag+Se→Ag₂Se

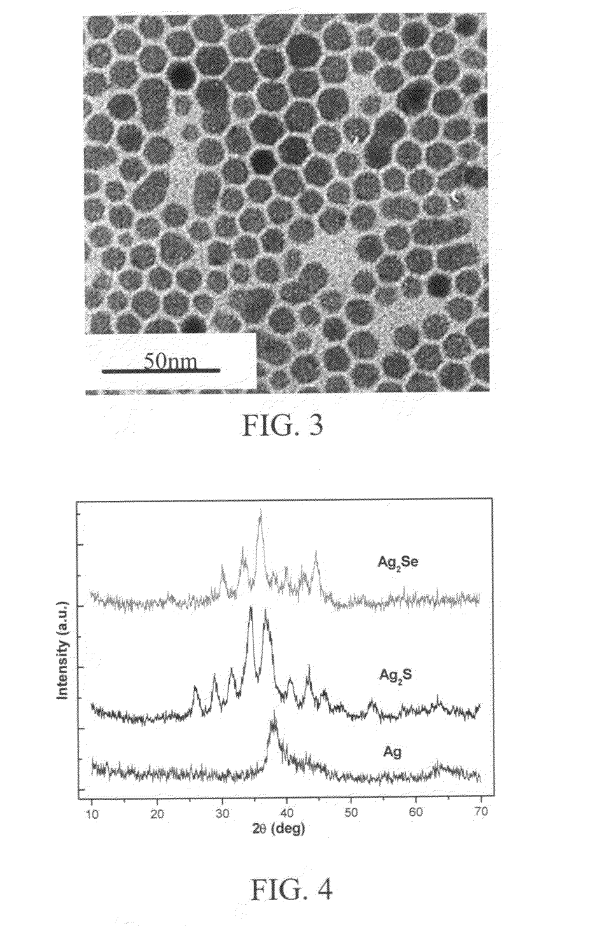

In a third embodiment, 0.85 g of AgNO3 solid are dissolved in 10 ml octadecyl amine, and a mixture is achieved. The mixture is agitated and reacted at a temperature of 200° C. for 10 minutes. 0.198 g of Se is mixed into the reactant, and the mixture is reacted for a period 10 minutes. The reactant is cooled to the temperature of 80° C., and a deposit is achieved. The deposit is washed with ethanol and dried at the temperature of 40-80° C. Referring to FIG. 3, monodisperse silver selenide nanocrystals with a diameter of about 8.5 nm are achieved.

Referring to FIG. 4, the monodisperse silver, silver sulfide, and silver selenide nanocrystals, according to the above embodiments, have perfect or at least near-perfect morphologies.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A method for making monodisperse silver nanocrystals comprising:
(1) mixing a silver nitrate with octadecyl amine as a solvent, and achieving a mixture;
(2) agitating and reacting the mixture at a reaction temperature for a reaction period;
(3) cooling the mixture to a cooling temperature, and achieving a deposit; and
(4) washing the deposit with an organic solvent, drying the deposit at a drying temperature, and achieving monodisperse silver nanocrystals.

2. The method for making monodisperse silver nanocrystals as claimed in claim 1, wherein a reaction temperature is in an approximate range of 160° C.-300° C.

3. The method for making monodisperse silver nanocrystals as claimed in claim 1, wherein a cooling temperature is in an approximate range of 70° C.-90° C.

4. The method for making monodisperse silver nanocrystals as claimed in claim 1, wherein a drying temperature is in an approximate range of 40° C.-80° C.

5. The method for making monodisperse silver nanocrystals as claimed in claim 1, wherein the monodisperse silver nanocrystals have a diameter of about 6 nm to 12 nm.

6. The method for making monodisperse silver nanocrystals as claimed in claim 1, wherein the organic solvent is ethanol.

7. The method for making the metal oxide as claimed in claim 1, wherein the reaction period is about 1 to 10 minutes.

8. A method for making monodisperse silver sulfide nanocrystals comprising:
(1) mixing a silver nitrate with octadecyl amine as a solvent, and achieving a mixture;
(2) agitating and reacting the mixture at a reaction temperature for a first reaction period;
(3) mixing a sulfur solid into the reactant and reacting for a second reaction period, achieving a mole ratio for silver nitrate to sulfur of 2:1;
(4) cooling to a temperature, and achieving a deposit; and
(5) washing the deposit with an organic solvent, drying the deposit at a drying temperature, and achieving monodisperse silver sulfide nanocrystals.

9. The method for making monodisperse silver sulfide nanocrystals as claimed in claim 8, wherein a reaction temperature is in an approximate range of 160° C.-300° C., a cooling temperature is in an approximate range of 70° C.-90° C., and a drying temperature is in an approximate range of 40° C.-80° C.

10. The method for making monodisperse silver sulfide nanocrystals as claimed in claim 8, wherein the monodisperse silver sulfide nanocrystals have a diameter of about 6 to 12 nm.

11. The method for making monodisperse silver sulfide nanocrystals as claimed in claim 8, wherein the organic solvent is ethanol.

12. The method for making monodisperse silver sulfide nanocrystals as claimed in claim 8, wherein the first reaction period is about 1 to 10 minutes, and the second reaction period is about 8 to 12 minutes.

13. A method for making monodisperse silver selenide nanocrystals comprising:
(1) mixing a silver nitrate with octadecyl amine as a solvent, and achieving a mixture;
(2) agitating and reacting the mixture at a reaction temperature for a first reaction period;
(3) mixing a selenium solid into the reactant and reacting for a second reaction period, achieving a mole ratio of silver nitrate to sulfur of 2:1;
(4) cooling to a temperature, and achieving a deposit; and
(5) washing the deposit with an organic solvent, drying the deposit at a drying temperature, and achieving monodisperse silver selenide nanocrystals.

14. The method for making monodisperse silver selenide nanocrystals as claimed in claim 13, wherein a reaction temperature is in an approximate range of 160° C.-300° C., a cooling temperature is in an approximate range of 70° C.-90° C., and a drying temperature is in an approximate range of 40° C.-80° C.

15. The method for making monodisperse silver selenide nanocrystals as claimed in claim 13, wherein the monodisperse silver selenide nanocrystals have a diameter of about 6 to 12 nm.

16. The method for making monodisperse silver selenide nanocrystals as claimed in claim 13, wherein the organic solvent is ethanol.

17. The method for making monodisperse silver selenide nanocrystals as claimed in claim 13, wherein the first reaction period is about 1 to 10 minutes, and the second reaction period is about 8 to 12 minutes.
